(19) United States
(12) Patent Application Publication
(10) Pub. No.: US 2025/0319585 A1
(43) Pub. Date: Oct. 16, 2025

(54) STORAGE DEVICE FOR COLLETS

(71) Applicant: REFINE MACHINERY CO., LTD., Taichung City (TW)

(72) Inventors: Hau-Hsuan Chang, Taichung City (TW); Hao-Che Chang, Taichung City (TW)

(21) Appl. No.: 19/085,097

(22) Filed: Mar. 20, 2025

(30) Foreign Application Priority Data
Apr. 10, 2024 (TW) 113113265

(51) Int. Cl. B25H 3/06

(52) U.S. Cl. CPC B25H 3/06

(57) ABSTRACT

A storage device for collets has a body and at least two mounting components. The body has a placing surface. The at least two mounting components are disposed on the placing surface at a spaced interval, extend out of the placing surface, and each one of the at least two mounting components is configured to be mounted in a tool clamping hole of a collet. The at least two mounting components have different outer diameters, such that the at least two mounting components are configured to mount the collets that have the tool clamping holes with different inner diameters. The storage device for collets can facilitate accurate storage, flexible configurations, and enhanced practicality.

### BACKGROUND OF THE INVENTION

### 1. Field of the Invention

The present invention relates to a storage device, and more particularly to a storage device for collets that can facilitate accurate storage, flexible configurations, and improved practicality.

### 2. Description of Related Art

With reference to FIGS. 14 and 15, a conventional storage device 50 for collets can provide a storage effect to collets 40, and has a storage box 51 and a protecting cover 52. The storage box 51 has multiple receiving recesses 511 formed in the storage box 51 at spaced intervals and are arranged in a checkerboard pattern. The multiple receiving recesses 511 are used for placing the collets 40 and have the same size, so as to store collets 40 of the same external size. Each one of the collets 40 is marked with a corresponding size symbol (corresponding to the size of a tool) on the outer surface of the collet 40. The protecting cover 52 is detachably mounted on the storage box 51 to prevent dust or impurities from accumulating on the collets 40 in the storage box 51.

Although the conventional storage device 50 can provide a storage effect to the collets 40, after long-term use, the size symbol on the outer surface of each one of the collets 40 will gradually wear off and cannot be clearly displayed. In addition, the receiving recesses 511 all have the same size. Therefore, the user cannot know the size symbols of the collets 40 as the collets 40 are placed in the receiving recesses 511 that look same-sized in appearance, and only by connecting each collet 40 with a tool to be used one by one can the user know whether the collet 40 taken out corresponds to the size of the tool, which is relatively inconvenient and time-consuming. Furthermore, the storage box 51 of the conventional storage device 50 has a certain volume and shape, and therefore can only store a certain number of collets 40, and cannot be adjusted according to the user's needs. For example, when the conventional storage device 50 is to be placed in a smaller space, the fixed storage box 51 cannot meet the above needs. In addition, when the number of collets 40 to be stored exceeds the number of the receiving recesses 511, since the conventional storage device 50 cannot meet the needs of the user, the user can only purchase another conventional storage device 50 for use, which relatively limits the practicality of the conventional storage device 50. Therefore, the conventional storage device 50 for collets has the above-mentioned problems and deficiencies and needs improvement.

The storage device for collets in accordance with the present invention mitigates or obviates the aforementioned problems.

### SUMMARY OF THE INVENTION

The main objective of the present invention is to provide a storage device for collets that can facilitate accurate storage, flexible configurations, and improved practicality.

The storage device for collets in accordance with the present invention has a body and at least two mounting components. The body has a placing surface. The at least two mounting components are disposed on the placing surface at a spaced interval, extend out of the placing surface, and each one of the at least two mounting components is configured to be mounted in a tool clamping hole of a collet. The at least two mounting components have different outer diameters, such that the at least two mounting components are configured to mount the collets that have the tool clamping holes with different inner diameters. The storage device for collets can facilitate accurate storage, flexible configurations, and improved practicality.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a storage device for collets in accordance with the present invention;

FIG. 2 is an exploded perspective view of the storage device for collets in FIG. 1;

FIG. 3 is a side view in partial section of the storage device for collets in FIG. 1;

FIG. 4 is a perspective view of a second embodiment of a storage device for collets in accordance with the present invention;

FIG. 5 is a side view in partial section of the storage device for collets in FIG. 4;

FIG. 6 is a perspective view of a third embodiment of a storage device for collets in accordance with the present invention;

FIG. 7 is an exploded perspective view of the storage device for collets in FIG. 6;

FIG. 8 is a side view in partial section of the storage device for collets in FIG. 6;

FIG. 9 is another exploded perspective view of the storage device for collets in FIG. 6;

FIG. 10A is an operational side view in partial section of the storage device for collets in FIG. 6;

FIG. 10B is another operational side view in partial section of the storage device for collets in FIG. 6;

FIG. 11 is an operational perspective view of the storage device for collets in FIG. 6;

FIG. 12 is an exploded top side view of a fourth embodiment of a storage device for collets in accordance with the present invention;

FIG. 13 is a top side view of the storage device for collets in FIG. 12;

FIG. 14 is an exploded perspective view of a storage device for collets in accordance with the prior art; and

FIG. 15 is a top side view of the storage device for collets in FIG. 14.

### DETAILED DESCRIPTION OF THE PREFERRED EMBODIMENT

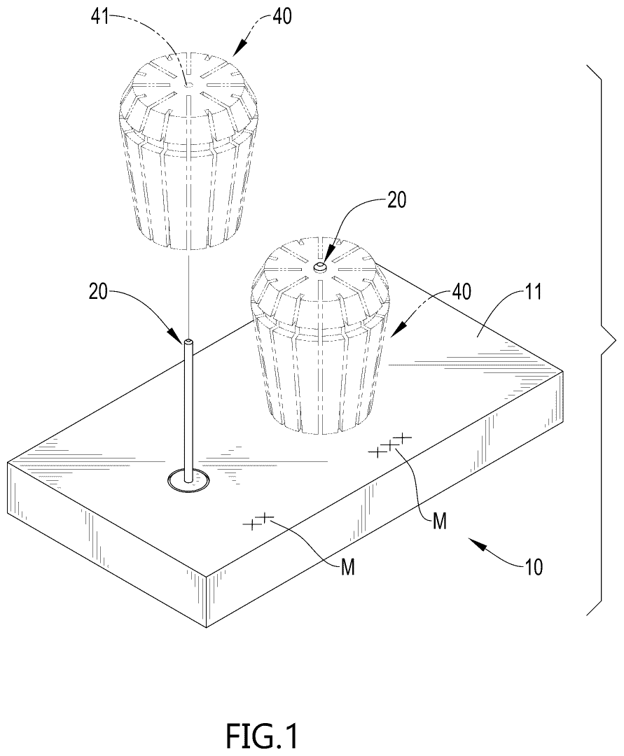

With reference to FIGS. 1 to 3, a first embodiment of a storage device for collets in accordance with the present invention has a body 10 and at least two mounting components 20.

The body 10 has a placing surface 11 disposed on a top side of the body 10 for placing the collets 40. In the first embodiment of the present invention, the body 10 is a board. The at least two mounting components 20 are disposed on the placing surface 11 at a spaced interval and extend out of the placing surface 11. Each one of the at least two mounting components 20 is used to be mounted in a tool clamping hole 41 of the collet 40, and the at least two mounting components 20 have different outer diameters, such that the at least two mounting components 20 can be used to mount the collets 40 that have the tool clamping holes 41 with different inner diameters. In addition, the body 10 has a size symbol M marked on the placing surface 11 corresponding to each one of the at least two mounting components 20, such that a user can store the collets 40 corresponding to the sizes of the tool clamp holes 41 via the at least two mounting components 20 with different outer diameters, and can also ensure to accurately store the collets 40 through the size symbols M marked on the placing surface 11 of the body 10.

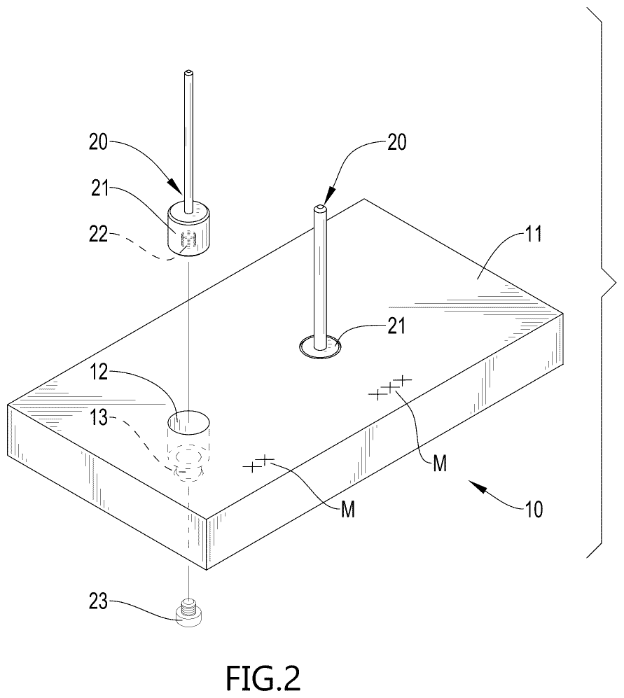

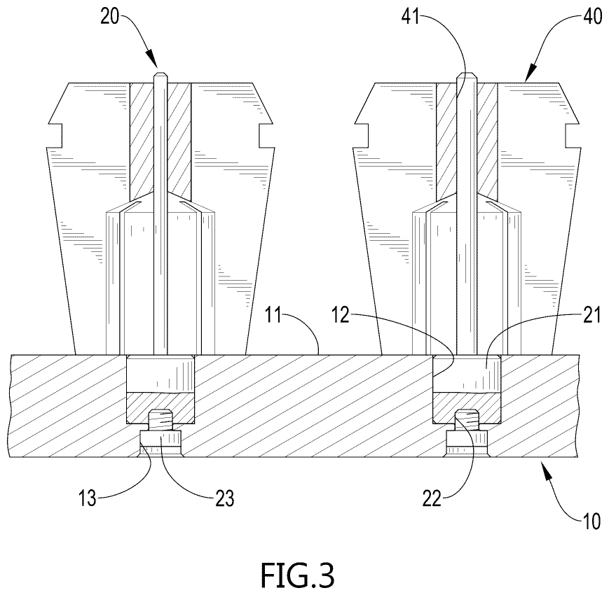

Furthermore, with reference to FIGS. 2 and 3, each one of the at least two mounting components 20 is detachably connected to the body 10, and the body 10 has connecting recesses 12 in the same number as the at least two mounting components 20. Each one of the connecting recesses 12 is formed in the placing surface 11, and each one of the at least two mounting components 20 has a base 21 disposed on an end of the mounting component 20 and mounted in one of the connecting recesses 12 of the body 10. By connecting the base 21 of each one of the at least two mounting components 20 with a corresponding connecting recess 12, each one of the at least two mounting components 20 is disposed on the placing surface 11 of the body 10. Preferably, the body 10 has through slots 13 in the same number as the connecting recesses 12, formed in a bottom surface of the body 10 opposite to the placing surface 11, and each one of the through slots 13 is formed through a bottom of a corresponding one of the connecting recesses 12 and spatially communicates with the corresponding connecting recess 12. Furthermore, each one of the through slots 13 has an inner diameter different from an inner diameter of the corresponding connecting recess 12 to form a stepped face between the through slot 13 and the corresponding connecting recess 12. Additionally, each one of the at least two mounting components 20 has a fixing hole 22 formed in a bottom of the base 21. The fixing hole 22 of each one of the at least two mounting components 20 aligns with the through slot 13 via a corresponding one of the connecting recesses 12. Each one of the at least two mounting components 20 has a fastener 23 connected to the fixing hole 22 via a corresponding through slot 13 and abutted against the stepped face between the corresponding through slot 13 and the connecting recess 12 to hold the mounting component 20 securely on the body 10.

According to the above-mentioned features and structural relationships of the first embodiment of the storage device of the present invention, in use, since each one of the at least two mounting components 20 has a different outer diameter, the collets 40 with tool clamping holes 41 of different inner diameters can be accurately stored, such that the user will not be unable to know the size of each collet 40 because each collet 40 has the same size in appearance or the size symbols on the outer surface of each collet 40 wear off after long-term use. Then the user does not need to connect each collet 40 with a tool to be used one by one to know whether the collet 40 corresponds to the size of the tool, and this is relatively convenient to use and saves time, thereby providing a storage device that can store the collets 40 accurately.

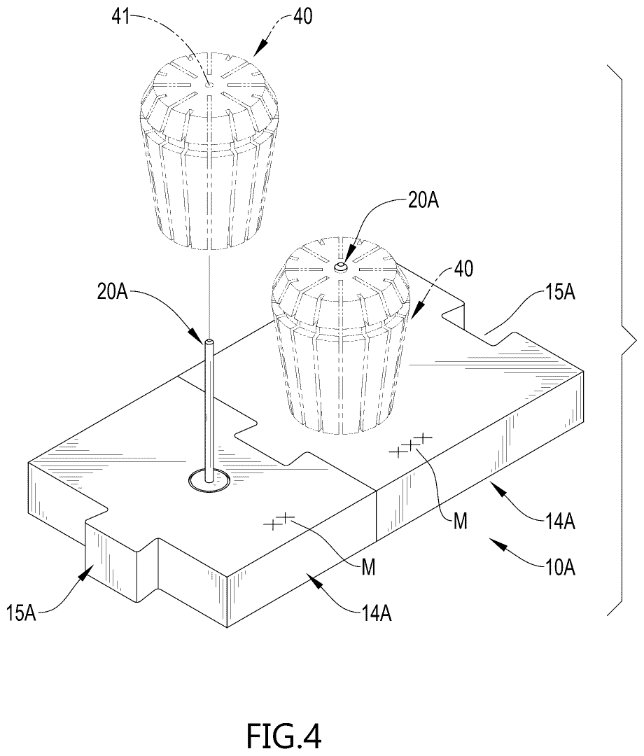

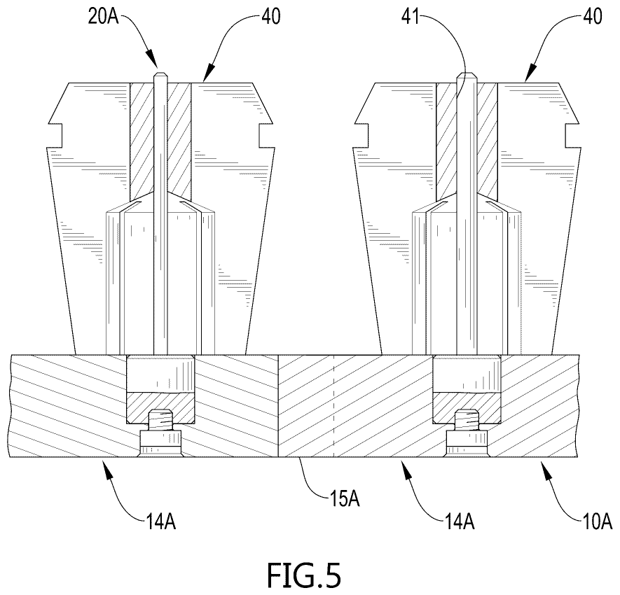

With reference to FIGS. 4 and 5, a second embodiment of a storage device for collets in accordance with the present invention is substantially the same as the first embodiment as shown in FIGS. 1 to 3 except for the following features. In the second embodiment of the storage device for collets of the present invention, the body 10A has assembling units 14A in the same number as the at least two mounting components 20A. The assembling units 14A can be connected or separated to form the body 10A, and each one of the assembling units 14A has at least one engaging portion 15A disposed on a side of the assembling unit 14A and may be a recess or a protrusion. Then two adjacent assembling units 14A can be connected to each other by the at least two engaging portions 15A. For example, the at least one engaging portion 15A of one of the two adjacent assembling units 14A is a recess, the at least one engaging portion 15A of the other one of the two adjacent assembling units 14A is a protrusion, and the recess can be connected to the protrusion to connect the two adjacent assembling units 14A with each other. Furthermore, each one of the at least two mounting components 20A is disposed on a respective one of the assembling units 14A, and each one of the assembling units 14A has the size symbol M corresponding to the mounting component 20A that is disposed on the assembling unit 14A. That is, the user can set up a plurality of assembling units 14A as needed, and set up a mounting component 20A on each one of the assembling units 14A, so as to store collets 40 of different quantities, thereby providing a storage device that can store the collets 40 accurately, can be configured flexibly, and can improve practicality.

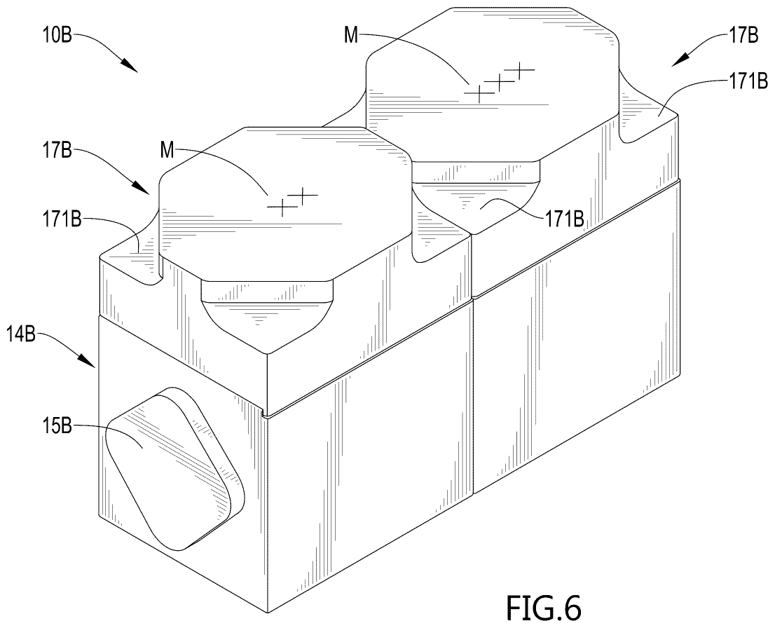

With reference to FIGS. 6 to 8, a third embodiment of a storage device for collets in accordance with the present invention is substantially the same as the second embodiment as shown in FIGS. 4 and 5 except for the following features. In the third embodiment of the storage device for collets of the present invention, each one of the assembling units 14B is a casing, and the casing has a receiving recess 16B for storing a collet 40 with an opening 161B. Each one of the at least two mounting components 20 is disposed in the receiving recess 16B of the one of the assembling units 14B and extends out of the opening 161B of the receiving recess 16B. The body 10B has a mounting cover 17B detachably mounted on each one of the assembling units 14B to cover a collet 40 between the mounting cover 17B and the corresponding assembling unit 14B. Preferably, each one of the assembling units 14B has an annular flange 141B formed on the assembling unit 14B around the opening 161B of the receiving recess 16B, and the mounting cover 17B is connected to the annular flange 141B to mount on the assembling unit 14B. Each mounting cover 17B has at least one holding portion 171B disposed on an outer surface of the mounting cover 17B, and a user can hold the at least one holding portion 171B to separate the mounting cover 17B from a corresponding one of the assembling units 14B to take the collet 40 out of the corresponding assembling unit 14. Preferably, each mounting cover 17B has four said holding portions 171B disposed on the outer surface of the mounting cover 17B at spaced intervals to allow the user to hold the four said holding portions 171B to separate the mounting cover 17B from the corresponding assembling unit 14B conveniently.

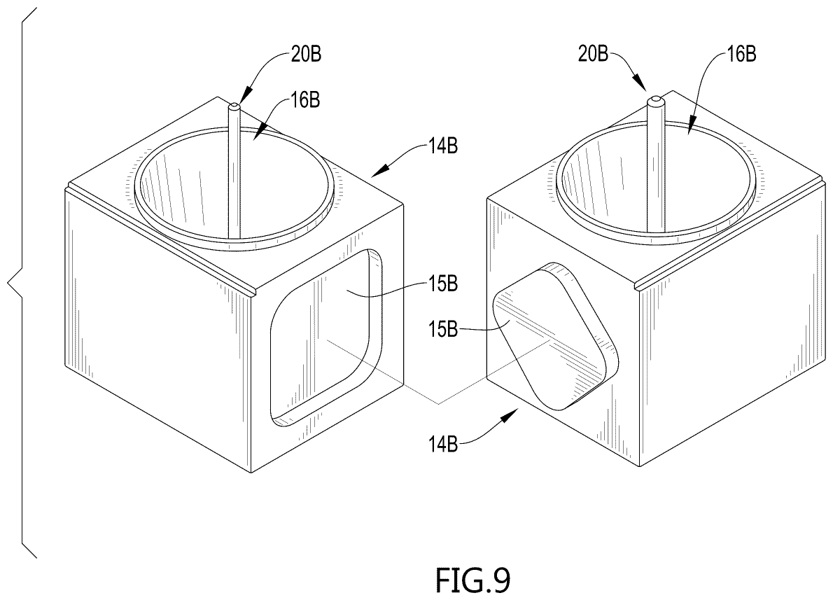

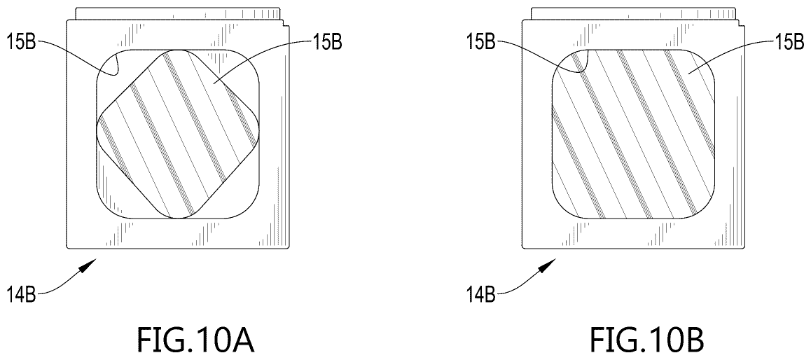

Furthermore, with reference to FIG. 9, each one of the assembling units 14B has two said engaging portions 15B respectively formed on two outer sides of the assembling unit 14B, one of the two said engaging portions 15B is a polygonal protrusion, and the other one of the two said engaging portions 15B is a polygonal recess. With reference to FIG. 10A, the corners of the polygonal protrusion engage with the inner sides of the polygonal recess to connect the two adjacent assembling units 14B with each other. With reference to FIG. 10B, the outer sides of the polygonal protrusion engage with the inner sides of the polygonal recess to connect the two adjacent assembling units 14B with each other. Therefore, it is only necessary for the engaging portions 15B between two adjacent assembling units 14B to be mutually engaged and separated, which is also the aspect to be protected by the present invention and is not limited here.

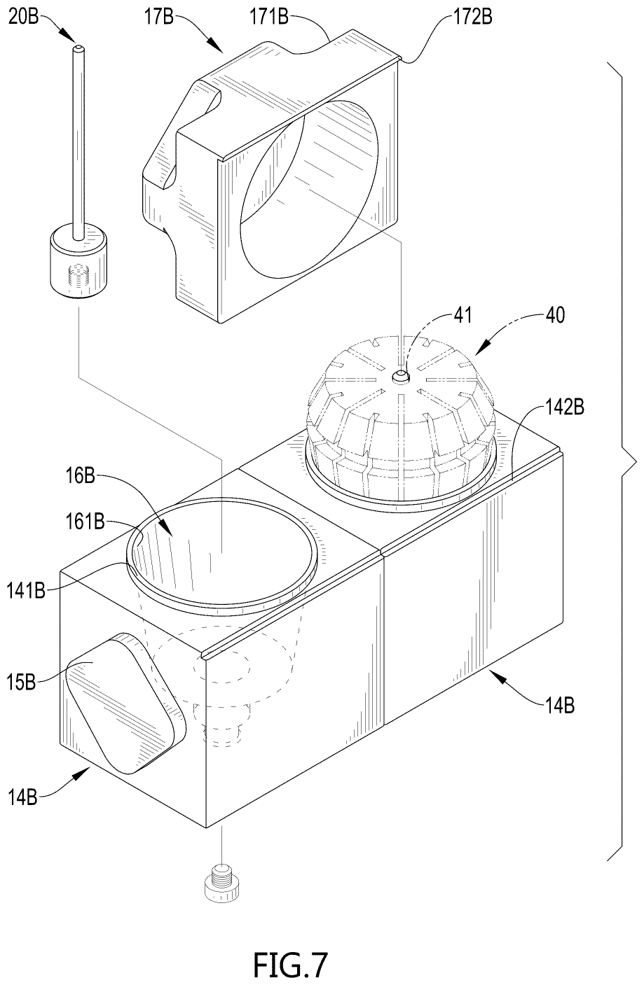

With reference to FIGS. 6 and 7, each assembling unit 14B has a positioning portion 142B disposed on a top side of the assembling unit 14B opposite to the two engaging portions 15B, and the mounting cover 17B has an aligning portion 172B formed on a bottom of the mounting cover 17B at a side of the mounting cover 17B. When the mounting cover 17B is mounted on a corresponding one of the assembling units 14B, the aligning portion 172B of the mounting cover 17B engages with the positioning portion 142B of the corresponding assembling unit 14B. The positioning portion 142B of each assembling unit 14B is a transversely positioning groove, and the aligning portion 172B of each mounting cover 17B is a transversely aligning rib. By connecting the aligning rib with the positioning groove, the mounting cover 17B can be mounted on the corresponding assembling unit 14B in a specific direction. Furthermore, the size symbol M of the body 10B is disposed on a top side of each one of the mounting covers 17B, and the user can easily and quickly know the position of the collet 40 of the desired size since the size symbols M of the mounting covers 17B of the body 10B face the same direction by the aligning portions 172B of the mounting covers 17B engaging with the positioning portions 142B of the assembling units 14B.

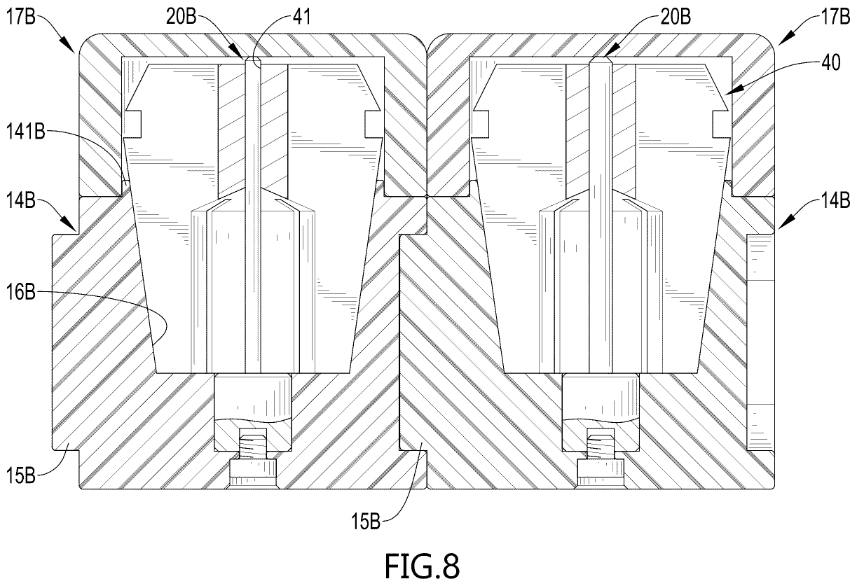

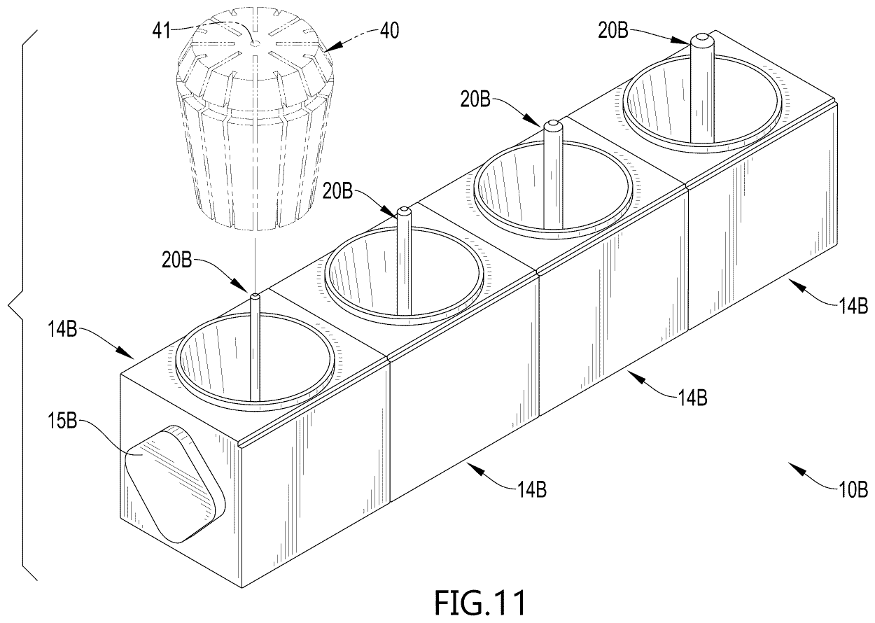

With reference to FIG. 11, when the third embodiment of a storage device for collets of the present invention is in use, the user can assemble several assembling units 14B according to needs through the engaging portions 15B of each assembling unit 14B, and flexibly adjust the overall volume and shape of the storage device for collets, such that the storage device for collets can be placed in a preset position or space according to the user's needs. In addition, the mounting components 20B of different sizes are respectively disposed in the assembling units 14B, collets 40 with tool clamping holes 41 of different sizes can be stored in corresponding assembling units 14B. Furthermore, with reference to FIGS. 7 and 8, each mounting cover 17B is mounted on a corresponding one of the assembling units 14B to store and keep the collets 40 of different sizes in the storage device. In this way, the collets 40 are accurately stored in corresponding assembly units 14B by the mounting components 20B with different sizes of outer diameters, and also the size symbols M are marked on each one of the mounting covers 17B to provide further size confirmation, such that the user can accurately and quickly store or take out the collet 40 of the desired size, thereby providing a storage device for collets that can facilitate accurate storage, flexible configurations, and improved practicality.

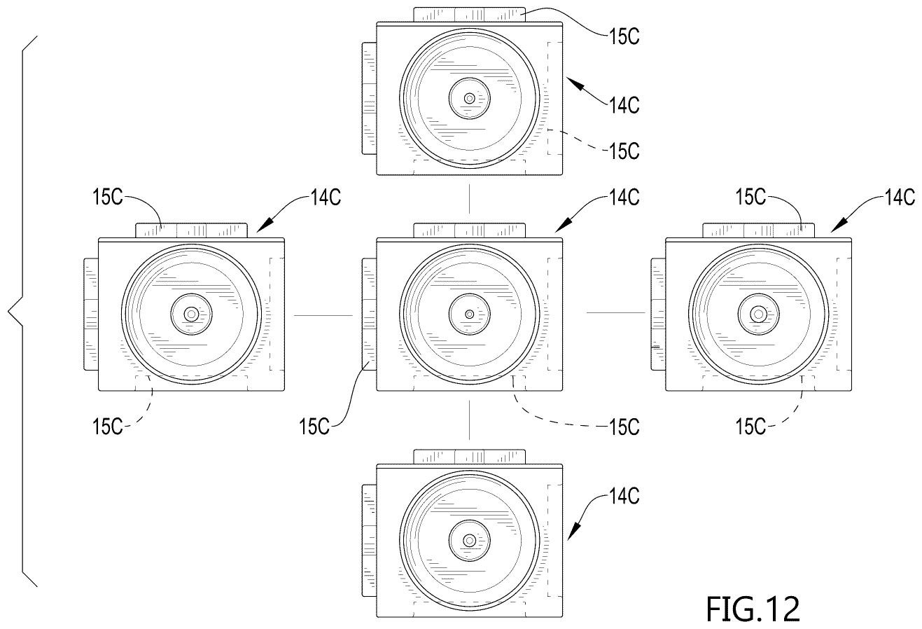

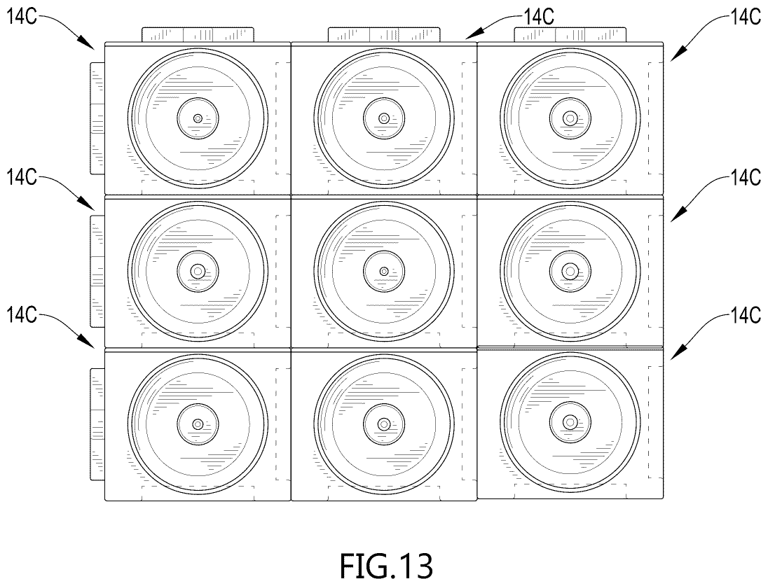

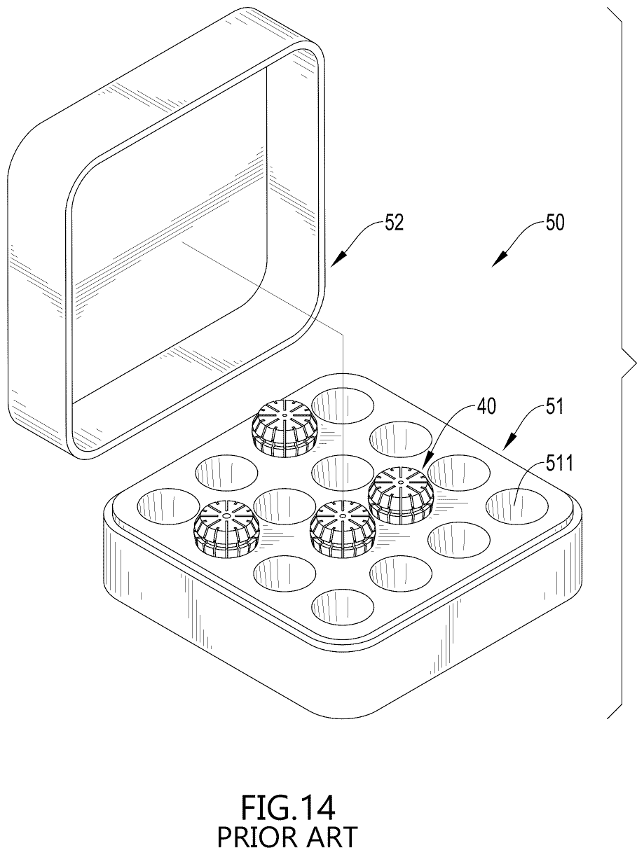

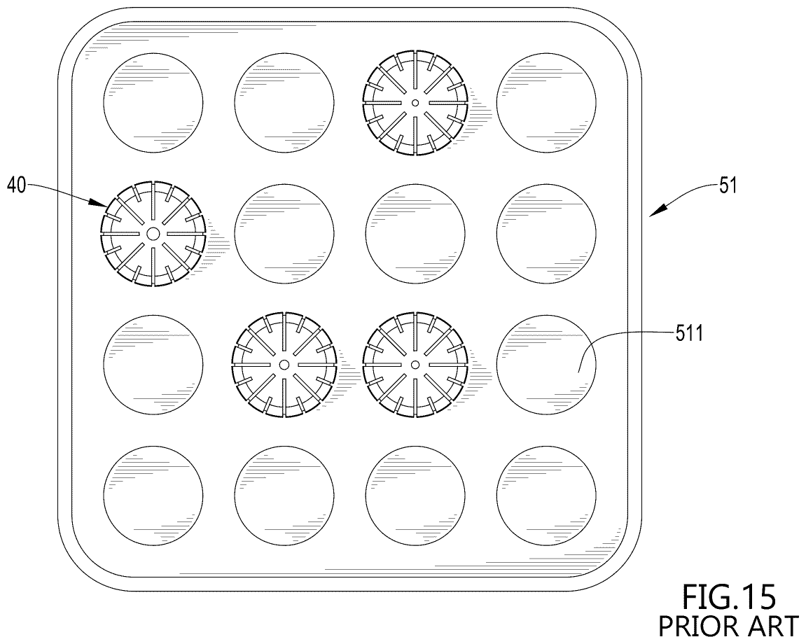

With reference to FIGS. 12 and 13, a fourth embodiment of a storage device for collets in accordance with the present invention is substantially the same as the third embodiment as shown in FIGS. 6 to 8 except for the following features. In the fourth embodiment of the storage device for collets of the present invention, each one of the assembling units 14C has four said engaging portions 15C respectively formed on four sides of the assembling unit 14C, then multiple said assembling units 14C can be assembled and connected in different directions as shown in FIG. 12. Preferably, two of the four said engaging portions 15C are polygonal protrusions, the other two of the four said engaging portions 15C are polygonal recesses, the two polygonal protrusions are formed on two adjacent sides of the assembling unit 14C, and two polygonal recesses are formed on the other two adjacent sides of the assembling unit 14C. Then, with reference to FIG. 13, a plurality of assembling units 14C arranged in a checkerboard pattern can be expanded according to the user's needs to accommodate a plurality of collets 40 with tool clamping holes 41 of different sizes, thereby providing a storage device for collets that can facilitate accurate storage, flexible configurations, and improved practicality.

According to the above-mentioned structural relationships and features of the storage device for collets of the present invention, the at least two mounting components 20, 20A, 20B are disposed on the body 10, 10A, 10B, and the at least two mounting components 20, 20A, 20B have different outer diameters, and this allows the users to accurately store the collets 40 with tool clamping holes 41 of different sizes in the corresponding positions of the body 10, 10A, 10B, such that the user can quickly find the collet 40 of the corresponding size via the size symbol M of the body 10, 10A, 10B when taking the collet 40, which can effectively avoid the situation that the size of each collet 40 cannot be accurately known because the collets 40 look same-sized in appearance or the size symbol M on the outer surfaces of the collets 40 are damaged and unclear after long-term use. It is no longer necessary to combine each collet 40 with a tool to be used one by one to know whether the taken collet 40 corresponds to the size of the tool, which is relatively convenient to use and saves time. Furthermore, each one of the assembling units 14A, 14B, 14C has the at least one engaging portion 15A, 15B, 15C, and this enables the user to flexibly adjust the volume and shape of the body 10A, 10B to form a plurality of structural configurations such as a strip, an L-shape, a cross or a chessboard arrangement by assembling a plurality of assembling units 14A, 14B, 14C according to the needs, in different spaces (small spaces or narrow spaces, etc.) or collet quantity requirements, so as to provide a storage device that can accurately store, can be flexibly configured, and can improve practicality.

Even though numerous characteristics and advantages of the present invention have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A storage device for collets comprising:
a body having a placing surface; and
at least two mounting components disposed on the placing surface at a spaced interval and extending out of the placing surface, each one of the at least two mounting components configured to be mounted in a tool clamping hole of a collet, and the at least two mounting components having different outer diameters, such that the at least two mounting components being configured to mount the collets that have the tool clamping holes with different inner diameters.

2. The storage device for collets as claimed in claim 1, wherein each one of the at least two mounting components has a respective size symbol marked on the placing surface of the body.

3. The storage device for collets as claimed in claim 1, wherein
the body has connecting recesses in a same number as the at least two mounting components;
each one of the connecting recesses is formed in the placing surface; and
each one of the at least two mounting components has a base disposed on an end of the mounting component and detachably mounted in a respective one of the connecting recesses of the body.

4. The storage device for collets as claimed in claim 2, wherein
the body has connecting recesses in a same number as the at least two mounting components;
each one of the connecting recesses is formed in the placing surface; and
each one of the at least two mounting components has a base disposed on an end of the mounting component and detachably mounted in a respective one of the connecting recesses of the body.

5. The storage device for collets as claimed in claim 3, wherein
the body has through slots in the same number as the connecting recesses and formed in a bottom surface of the body opposite to the placing surface;
each one of the through slots is formed through a bottom of a corresponding one of the connecting recesses and spatially communicates with the corresponding connecting recess; and
each one of the at least two mounting components has
a fixing hole formed in a bottom of the base and aligning with the through slot via a corresponding one of the connecting recesses; and
a fastener connected to the fixing hole.

6. The storage device for collets as claimed in claim 4, wherein
the body has through slots in the same number as the connecting recesses and formed in a bottom surface of the body opposite to the placing surface;
each one of the through slots is formed through a bottom of a corresponding one of the connecting recesses and spatially communicates with the corresponding connecting recess; and
each one of the at least two mounting components has
a fixing hole formed in a bottom of the base and aligning with the through slot via a corresponding one of the connecting recesses; and
a fastener connected to the fixing hole.

7. The storage device for collets as claimed in claim 1, wherein
the body has assembling units in a same number as the at least two mounting components;
the assembling units are detachably connected to each other to form the body, each one of the assembling units has at least one engaging portion disposed on a side of the assembling unit, and two adjacent ones of the assembling units are connected to each other by the at least two engaging portions of the two adjacent ones of the assembling units engaging with each other; and
each one of the at least two mounting components is disposed on a respective one of the assembling units.

8. The storage device for collets as claimed in claim 7, wherein each one of the assembling units of the body has a respective size symbol corresponding to the mounting component that is disposed on the assembling unit.

9. The storage device for collets as claimed in claim 7, wherein
each one of the assembling units is a casing, and the casing has a receiving recess for storing the collet with an opening; and
each one of the at least two mounting components is disposed in the receiving recess of the respective one of the assembling units and extends out of the opening of the receiving recess.

10. The storage device for collets as claimed in claim 8, wherein
each one of the assembling units is a casing, and the casing has a receiving recess for storing the collet with an opening; and
each one of the at least two mounting components is disposed in the receiving recess of the respective one of the assembling units and extends out of the opening of the receiving recess.

11. The storage device for collets as claimed in claim 9, wherein the body has a mounting cover detachably mounted on each one of the assembling units to cover the collet between the mounting cover and the assembling unit.

12. The storage device for collets as claimed in claim 10, wherein the body has a mounting cover detachably mounted on each one of the assembling units to cover the collet between the mounting cover and the assembling unit.

13. The storage device for collets as claimed in claim 11, wherein
each one of the assembling units has an annular flange formed on the assembling unit around the opening of the receiving recess; and
each one of the mounting covers is connected to the annular flange of a respective one of the assembling units to mount on the assembling unit.

14. The storage device for collets as claimed in claim 12, wherein
each one of the assembling units has an annular flange formed on the assembling unit around the opening of the receiving recess; and
each one of the mounting covers is connected to the annular flange of a respective one of the assembling units to mount on the assembling unit.

15. The storage device for collets as claimed in claim 11, wherein each mounting cover has at least one holding portion disposed on an outer surface of the mounting cover to allow a user to hold the at least one holding portion to separate the mounting cover from a corresponding one of the assembling units to take the collet out of the corresponding assembling unit.

16. The storage device for collets as claimed in claim 12, wherein each mounting cover has at least one holding portion disposed on an outer surface of the mounting cover to allow a user to hold the at least one holding portion to separate the mounting cover from a corresponding one of the assembling units to take the collet out of the corresponding assembling unit.

17. The storage device for collets as claimed in claim 7, wherein each one of the assembling units has two said engaging portions respectively formed on two outer sides of the assembling unit.

18. The storage device for collets as claimed in claim 11, wherein
each one of the assembling units has a positioning portion disposed on a top side of the assembling unit;
each one of the mounting covers has an aligning portion formed on a bottom of the mounting cover at a side of the mounting cover;
when each one of the mounting covers is mounted on a corresponding one of the assembling units, the aligning portion of the mounting cover engages with the positioning portion of the corresponding assembling unit.

19. The storage device for collets as claimed in claim 12, wherein
each one of the assembling units has a positioning portion disposed on a top side of the assembling unit;
each one of the mounting covers has an aligning portion formed on a bottom of the mounting cover at a side of the mounting cover;
when each one of the mounting covers is mounted on a corresponding one of the assembling units, the aligning portion of the mounting cover engages with the positioning portion of the corresponding assembling unit.

20. The storage device for collets as claimed in claim 18, wherein
a top side of each one of the mounting covers of the body has a respective size symbol; and
the size symbols of the mounting covers of the body face the same direction by the aligning portions of the mounting covers engaging with the positioning portions of the assembling units.

21. The storage device for collets as claimed in claim 19, wherein
a top side of each one of the mounting covers of the body has a respective size symbol; and
the size symbols of the mounting covers of the body face the same direction by the aligning portions of the mounting covers engaging with the positioning portions of the assembling units.

22. The storage device for collets as claimed in claim 7, wherein each one of the assembling units has four said engaging portions respectively formed on four sides of the assembling unit.
